(19) United States
(12) Patent Application Publication
(10) Pub. No.: US 2007/0274506 A1
(43) Pub. Date: Nov. 29, 2007

(54) DISTRIBUTED CALL CENTER SYSTEM AND METHOD FOR VOLUNTEER MOBILIZATION

(76) Inventor: Bret Schundler, Jersey City, NJ (US)

Correspondence Address: SYNNESTVEDT LECHNER & WOODBRIDGE LLP, P O BOX 592, 112 NASSAU STREET, PRINCETON, NJ, 08542-0592, US

(21) Appl. No.: 11/757,986

(22) Filed: Jun. 4, 2007

Related U.S. Application Data
(63) Continuation-in-part of application No. 10/595,111, now abandoned.
(60) Provisional application No. 60/803,738, filed on Jun. 2, 2006.
(60) Provisional application No. 60/496,518, filed on Aug. 20, 2003.

(51) Int. Cl. H04M 3/00; H04M 5/00

(52) U.S. Cl. 379/265.01

(57) ABSTRACT

A system and method to facilitate effective telephone calling campaigns that may be conducted by geographically dispersed individuals using inexpensive communications systems, such as the Internet and a basic telephone service. The system manages lists of pre-qualified prospects divided up among a group of volunteers, including providing the volunteers with prepared scripts via web-browsers, customized to both the volunteer and the prospect and designed to solicit further information and support from the prospects. The system also processes prospect responses and oversees appropriate follow-up actions such as sending pre-prepared e-mail or direct mail packages. The system also manages and serves information and links backgrounding campaign issues, strategies and tactics and providing volunteers with technical and motivational assistance. The system of this invention is also capable of monitoring volunteer productivity and effectiveness.

### CROSS-REFERENCE TO RELATED APPLICATIONS

This application is a continuation-in-part of U.S. application Ser. No. 10/595,111, filed Feb. 17, 2006, which is related to, and claims priority from PCT/US2004/027142 filed on Aug. 19, 2004 titled “Distributed Call Center System and Method for Volunteer Mobilization”, which claims priority from U.S. Provisional Patent application No. 60/496,518 filed on Aug. 20, 2003 titled “Distributed Call Center System and Method for Volunteer Mobilization”, all the contents of which are hereby incorporated by reference. This application is related to, and claims priority from U.S. Provisional Application No. 60/803,738, filed Jun. 2, 2006, the contents of which are hereby incorporated fully by reference.

### FIELD OF THE INVENTION

The present invention relates to distributed call center systems and technology and particularly to low cost, web-base call center systems and methods for coordinating home-based volunteers.

### BACKGROUND OF THE INVENTION

Telephone call centers that handle large volumes of inbound or outbound telephone calls usually automate much of the process by using sophisticated, expensive automatic dialing and routing equipment, a pool of trained, professional agents and sophisticated, expensive software to manage the process.

A typical use of such a call center is to initiate an outbound call campaign to contact a predefined group or segment of customers or potential customers that have a common attribute. An example of a business or commercial call campaign may be contacting persons having credit card accounts overdue by 60 days. A business or commercial call center typically handles such a campaign using a call center management system that identifies and downloads lists of appropriate telephone numbers which are fed to automatic phone dialers which then route connected calls to one of a pool of professional, qualified agents. Such systems are described in for example, U.S. Pat. No. 6,549,769 to Harder entitled “System and Method for Integrating Text Messaging to an Outbound Call System”, the contents of which are hereby incorporated by reference.

Some businesses operate virtual call centers in which calls are routed to agents at different geographic locations as described in, for example, U.S. Pat. No. 6,553,113 to Dhir et al. entitled “System and methods for call decisioning in a virtual call center integrating telephony with computers”, the contents of which are hereby incorporated by reference.

Existing call centers and the call center management systems cater primarily to business and commercial enterprises that can afford a pool of trained, professional agents and the sophisticated hardware and software systems to effectively make and manage the calls and the support personal.

There are other groups such as, but not limited to, grass roots political campaigns that would like to conduct telephone call campaigns but cannot afford the technology, the professional agents or the professional call centers. These groups do however often have large numbers of volunteers. However, these volunteers are often untrained, geographically dispersed and the only relevant technology they have access to is their basic telephone and Internet services.

What these groups need to realize their telephone call campaign ambitions is a low cost system that can integrate and manage the efforts of geographically dispersed volunteer groups, enabling them to mount low cost but effective calling campaigns using simple and widely available technology such as the Internet and the basic telephone service.

### SUMMARY OF THE INVENTION

Briefly described, the present invention comprises improvements to a system and method to facilitate effective telephone calling campaigns by geographically dispersed individuals using the Internet and basic telephone services.

The present invention provides to a communications management method for a distributed call center, comprising providing a managing server; providing a display device located geographically distant from said managing server; providing a communications device, located in proximity to said display device; providing an operator capable of operating said communications device; sending a message template and prospect identification information related to a prospect from said managing server to said display device; displaying, on said display device, said message template and said identification information; initiating communication with said prospect, by said operator, using said identification information and said communications device; creating a customized message using said message template and said prospect identification information; conveying, by said operator, said customized message to said named prospect; and recording a response of said prospect by said operator, and sending said recorded response to said managing server, an improvement comprising: automatically preparing and sending a follow-up communication to said named prospect when said operator records the response of said named prospect. The present invention also provides the automatic generation of a follow-up communication to said named prospect for each question answered by said named prospect, and further provides assigning at least one volunteer-type code to each volunteer based on a type of volunteer assignment to be performed by each volunteer; identifying a volunteer assignment type associated with each type of volunteer assignment; and establishing an assignment queue which automatically assigns assignments to by based on the volunteer assignment type. Further, the present invention provides a system and apparatus for performing the above methods.

The invention may be more fully understood by reference to the following drawings.

### BRIEF DESCRIPTION OF DRAWINGS

FIG. 1 is a schematic representation of a distributed call center.

FIG. 2 is a schematic representation of a volunteer's welcome page.

FIG. 3 is a schematic representation of a prospect call page.

FIG. 4 is a schematic flowchart of a volunteer using the system.

FIG. 5 is a schematic flowchart of the present invention managing a user interaction.

FIG. 6 is an exemplary log-on page.

FIG. 7 is an exemplary administrator's welcome page.

FIG. 8 is an exemplary administrator's list overview page.

FIG. 9 is an exemplary administrator's list management page.

FIG. 10 is an exemplary administrator's script management page.

FIG. 11 is an exemplary administrator's volunteer enrollment and assignment page.

FIG. 12 is an exemplary administrator's volunteer management page.

FIG. 13 is an exemplary volunteer's action page.

### DETAILED DESCRIPTION

During the course of this description like numbers will be used to identify like elements according to the different views that illustrate the invention.

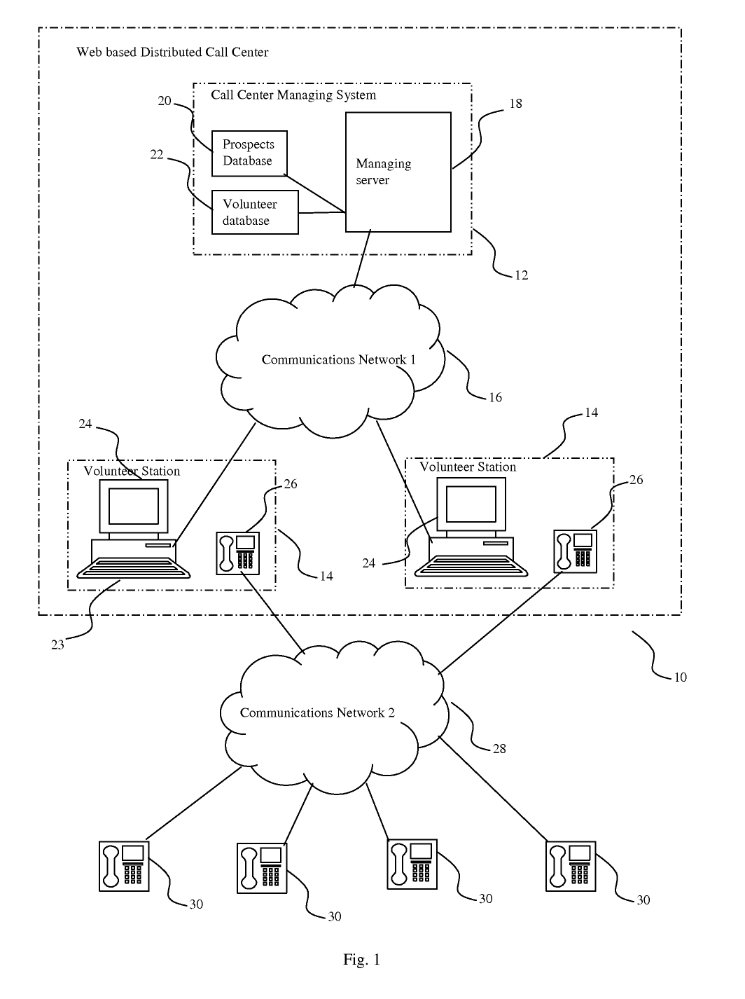

FIG. 1 shows a schematic representation of a web based distributed call center 10 comprising a call center management system 12 connected to at least one volunteer station 14 by a first communications network 16. The call center management system 12 includes a managing server 18 and associated prospect database 20 and volunteer database 22. In the preferred embodiment of the present invention the call center management system 12 is located to be geographically distant from the caller or volunteer stations 14. (The remote stations are termed ‘volunteer stations’ because, in political campaigns, the operatives typically volunteer their services to the campaign. It will be readily appreciated by one skilled in the art that the systems and methods described herein will function equally well if the operators of the volunteer stations are not volunteers but are compensated as professionals). The volunteer stations 14 typically comprise a data processing unit 23, a display device 24 and a communications device 26, preferably located in proximity to each other. The data processing unit 23 may be, but is not limited to, a personal computer, a personal digital assistant, a cable television set top box or a mobile telephone. The display device 24 may be, but is not limited to, the screen of a personal computer, the screen of a personal digital assistant, the screen of a television or the screen of a mobile telephone. The communications device 26 may be, but is not limited to, a telephone, a cellular telephone or a personal digital assistant (PDA) adapted for audio communication. The volunteer station 14 data processing units 23 comprise suitable communications software and hardware, including any necessary modems, to communicate with the managing server 12 via a first communications network 16 which may for example be, but is not limited to, the Internet or World Wide Web (WWW) or wireless network connection. The volunteer station communication devices 26 are able to access prospect telephones 30 via a second suitable communications network 28 such as, but not limited to the Public Telephone Network, a wireless network, a cable network or a satellite network. The audio communications link between the communication devices 26 and the prospect telephones 30 may be a conventional telephone link, a voice over internet protocol (VOIP) link, or some suitable combination of these. In a further embodiment of the invention, the first communications network 16 and the second communications network 28 may be the same network or share parts of the same network.

The distributed call center 10 architecture shown in FIG. 1 differs from conventional call centers as described in for instance, but not limited to, U.S. Pat. No. 6,553,113 to Dhir et al. entitled “System and methods for call decisioning in a virtual call center integrating telephony with computers”, the contents of which are hereby incorporated by reference, in a number of significant ways. In conventional call centers, a key component is an expensive automated dialing system used to make the initial calls from pre-sorted lists to prospects. When the call connects to a prospect, further call management systems then route the connected call to an available agent. In such systems the call initiation and distribution is centralized even though the agents may be distributed. In contrast, in a preferred embodiment of the distributed call center 10 of the present invention, the managing server 18 does not participate in directly placing or routing calls. Instead, the managing server 18 generates and makes available to the distributed volunteer stations 14, lists of prospects and their related prospect identification information, including, for instance their name and contact information. The managing server 18 also makes available at least one web page, which may be customized to reflect known information about both the volunteer and the prospect, that presents coordinating information, which may include message templates in the form of calling scripts, to the volunteers via their display screens 24. Customized messages may be created from these message templates, either by the managing server 18, by the remote data processing unit 23 or by the operator of the communications device 26. In the distributed call center 10 of the present invention the volunteer (also know as “the operator”) then initiates communication with the prospect using the communications device 26 and the prospect identification information. In a preferred embodiment, the operator may, for instance, initiate communication by dialing or placing a telephone call to the prospect. In this manner an inexpensive but effective telephone calling campaign can be launched using low cost, readily available hardware and the efforts of a distributed volunteer workforce, typically working out of their home.

Although the exemplary embodiment of the invention described thus far comprises a telephone calling campaign, one skilled in the art will appreciate that the system would work using other communications protocols such as, but not limited to, instant messaging or e-mail exchanges or some combination of them.

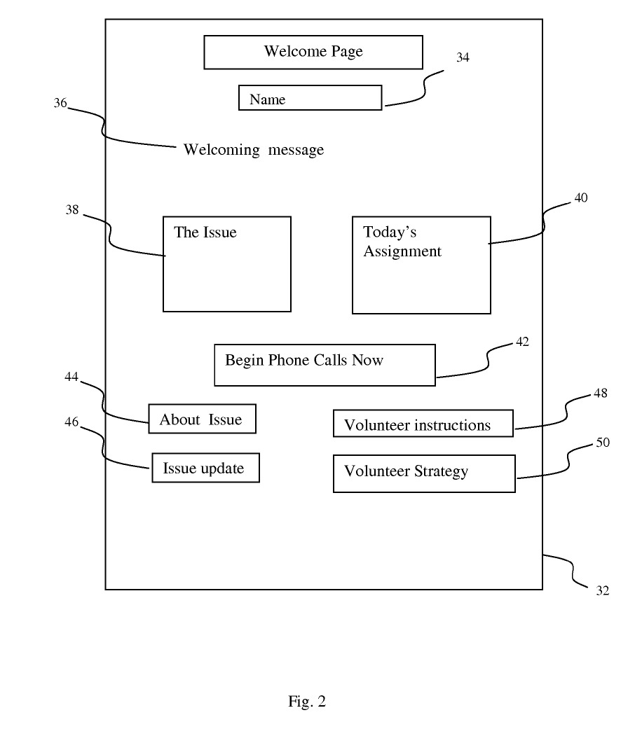

FIG. 2 shows a schematic drawing a welcome page 32 generated in the preferred embodiment of the invention. The page may be, but is not limited to, an Active Server Page (ASP) formatted in a formatting language, such as Hyper Text Mark Up Language (HTML), suitable for use on the Internet or World Wide Web (WWW). The page may be generated by, for instance, server software running on a suitable hardware platform. The welcome page 32 is formatted to display a number of elements of use to a volunteer in a telephone calling campaign. A name text box 34 shows the volunteers name and a message area contains welcoming message 36, which may be personalized. The welcoming message 36 is typically a brief, upbeat headline to orient the volunteer to the task. An example of a welcoming message 36 may be:

“Thanks for volunteering to help pass Empower the People's ” Return the Money Amendment“to the New Jersey Constitution”.

Other message areas that appear on the welcome page 32 in the preferred embodiment are an issue message 38 and an assignment message 40. The issue message 38 is typically a slightly more expansive outline of the issue that the current telephone calling campaign is addressing and may indicate where in-depth information about the campaign can be found and may also contain text designed to motivate or activate the volunteer to start telephoning. An example of a issue message 38 may be:

“We're working on the ” Fiscal Fairness and Responsibility Act“—which is more commonly called the Return the Money Amendment. You can read more about the Amendment and its Progress to Passage by clicking on the appropriate box below. Alternatively, you can click on the big box at the bottom of this page to being making phone calls now.”

The assignment message 40 is typically a tactical message, telling the volunteer what is being done on this particular day. The assignment message 40 may also indicated to the volunteer where they can find detailed information on technicalities such as volunteer instructions or volunteer strategy, as well as having motivational text designed to help integrate the volunteer into the group as well as to get the volunteer phoning prospects. An example of an assignment message 40 may be:

“Today we'll be working to organize supporters of the Return the Money Amendment in New Jersey's [#] State Legislative District. Before you begin, you may want to review our Volunteer Strategy or Volunteer Instructions, which you can do below. Alternatively, you can click on the big box at the bottom of this page to begin making phone calls now”.

Although the messages above have, for ease of description been described as text messages, one of skill in the art would appreciate that any suitable, web-compliant multimedia-elements could be incorporated into such messages including, but not limited to, still and animated graphics in for instance, well known jpeg, mpeg, gif and avi file formats, audio clips in for instance well-known wave or mp3 formats and video clips in for instance the well-known mpeg3 or mpeg4 formats.

The welcome page 32 also has links that may take the volunteer to other suitable web pages. For instance action link 42, which may be a well-known hypertext link embedded in an HTML button, will signal the managing server to serve up a prospect call page 52. Other hyper links found in the welcome page 32 of the preferred embodiment include an “About issue” link 44, an “Issue update” link 46, a “Volunteer Instructions” link 48 and a “Volunteer Strategy” link 50. Clicking on one of these links typically causes a new web page to be served up to the volunteer's computer. The new web page may provide detailed information, which may be customized to reflect known information about the volunteer, using for instance, well-known ASP technology and information from the volunteer database that the distributed call center management software maintains.

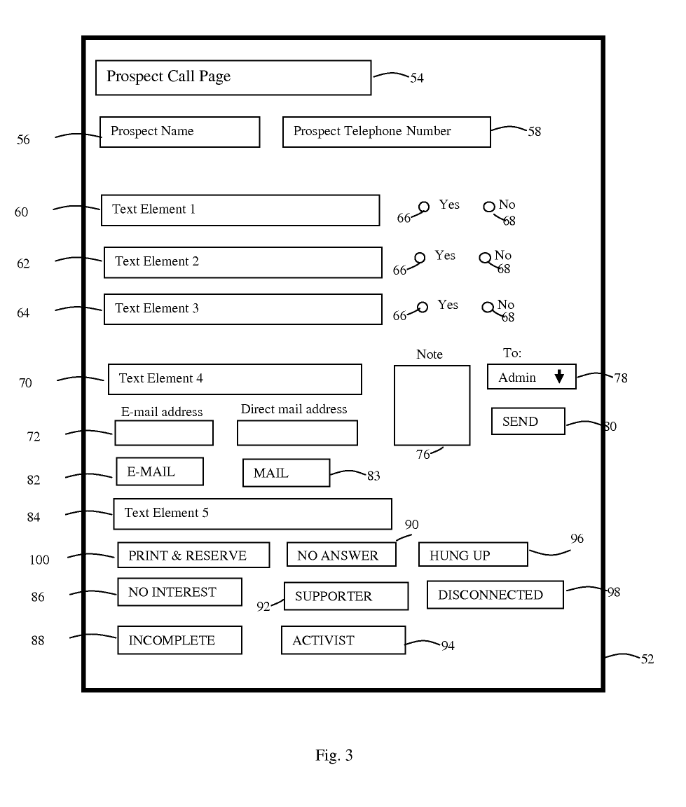

FIG. 3 is a schematic view of a prospect call page 52 served up in the preferred embodiment of the invention. The prospect call page 52 may be, but is not limited to, a customized HTML page created by ASP technology and may be customized to known information about the pre-qualified prospect and to the volunteer. In a preferred embodiment of the present invention, the prospect call page includes a heading 54, which may for instance be personalized to include the volunteers name and may include suitable links, dates and times. The prospect call page 52 may also include information about the prospect to be called including a prospect name 56 and a prospect telephone number 58. Other prospect related elements that may be present include, but are not limited to, a prospect address, including apartment or street number, street, town, state and country, details on if and when the prospect was previously contacted, prospect age, gender and other appropriate demographics.

The prospect page then typically includes a number of text or script elements 60, 62 and 64. Each of the text or script elements is typically a personalized script containing a question. For instance, text element 60 may read

“Hi, my name is JOHN. I'm a volunteer for Empower the People, the citizens group fighting to solve property tax problems. JOAN PROSPECT, our computer called your home on 10/23/2002 at 21:23 and recorded that you said you'd be willing to sign our petition to stop sky-rocketing property taxes. Do you agree that property taxes in PHILLIPSBURG are too high?”

Associated with the text element to be read by the volunteer are simple means for recording the prospect's response. In the preferred embodiment the recording means are single input check boxes labeled ‘yes’ or ‘no’. In another embodiment of the invention, the recording means may include more complex choices including, but not limited to, check boxes or pull down menus including options for ‘not sure’, ‘no comment’ or other possible response. Once the volunteer gets a response from the prospect, the volunteer checks the appropriate box. This data may be sent immediately back to the call center managing system 12 or it may be stored locally on the volunteer station 24 and sent back later.

The second text element 62 may be a pre-defined message sent at the same time as the first text element. In one embodiment of the invention, the second text element 62 is only sent after a response to the first text element has been registered and the second text element 62 may differ depending on what response is recorded. An example of a second text element 62 may be

“A big part of PHILLIPSBURG'S property tax problem is that PHILLIPSBURG's residents pay millions in sales and income taxes to New Jersey's state government in Trenton, but PHILLIPSBURG'S public schools and municipal government don't get the state funding they deserve in return. Our group is working to pass legislation that would make it harder for politicians to raise your state taxes, while returning more of the state taxes you already pay for community. Would you support legislation that increases state funding for your public schools and municipal government and lowers your property taxes?”

The second text element 62 may also have response buttons such as a ‘yes’ check box 66 and a ‘no’ check box 68 associated with it.

A third text element 64 may be part of the original script or generated as a consequence of recorded responses to previous text elements. Example a third text element are:

“Would you, JOAN PROSPECT, be willing to sign a petition to Governor McGreevey in support of such legislation?”

“Would you be willing to ask your state legislators to support such legislation?”

A forth text or script element 70 illustrates a more complex, multi-conditional type of statement or question requiring support for a more complex set of actions. Such a statement may be similar to a salespersons “closer”. An example of such a more complex script element 70 is

“If you are able to receive e-mail, I'd like to e-mail you information about the legislation we're pushing together with a petition we would like you to sign in support of it, and the names and phone numbers of your state legislators. JOAN PROSPECT, are you able to receive e-mail?”

Examples of more complex support buttons include element for recording an e-mail address 72, which may be, but is not limited to, an HTML or Javascript textbox. Other support buttons include an element for recording a direct mail address 74, and element for recording a note 76, and element for choosing where to send the note to 78 and well as function buttons for sending the note 80, for sending a prepackaged e-mail response 82 and for initiating sending a pre-packaged mailer 84.

A fifth text element 84 may be used for sending a closing message. As with all the other text elements, closing message 84 may be present when prospect call page 52 is first opened or delivered or it may be generated in a particular format as a consequence of responses to previous text elements. An example of a closing message 84 may be

“After you read through what we send you, please sign and return our petition, and please call your state legislators and ask them to support our legislation. So, please, make your 20-second calls to your legislators. We are counting on you. And please let us know that you have completed your calls. The materials we send you will tell you how you can communicate back to us. Thank you very much for being willing to help. Bye.”

Prospect call page 52 may also include specialize buttons for recording common user responses or situations. For instance, buttons may include, but are not limited to, a ‘No Answer’ button 90, a ‘Hung up’ button 96, a ‘No interest’ button 86, a ‘Supporter’ button 92, a ‘Disconnected’ button 98, an ‘Incomplete’ button 88 and an ‘Activist’ button 94. These buttons may send information back to the Call Center Managing System allowing it to update the prospects database 20, including categorizing the lists that the current prospect will be used in. The responses sent back may also be used by the call centering managing system to update data on the volunteer database, including updating determinations of the volunteer's productivity and effectiveness.

Function button ‘Print and Reserve’ is used for a further capability of the system in the preferred embodiment of the system. By pushing the ‘Print and Reserve’ button the volunteer is able to print out all the information normally on the screen and thereby go off line from the Call Center Managing System 10. The managing server 12 will record that the particular Prospect has been checked out and will not reallocate the Prospect to any other volunteers until it has been checked back in or a predetermined time has passed. In the preferred embodiment of the system prospects can be checked out in this manner for a maximum of 24 hours, although the time limit will depend on the nature of the calling campaign being conducted, the type of prospect and the type of volunteer.

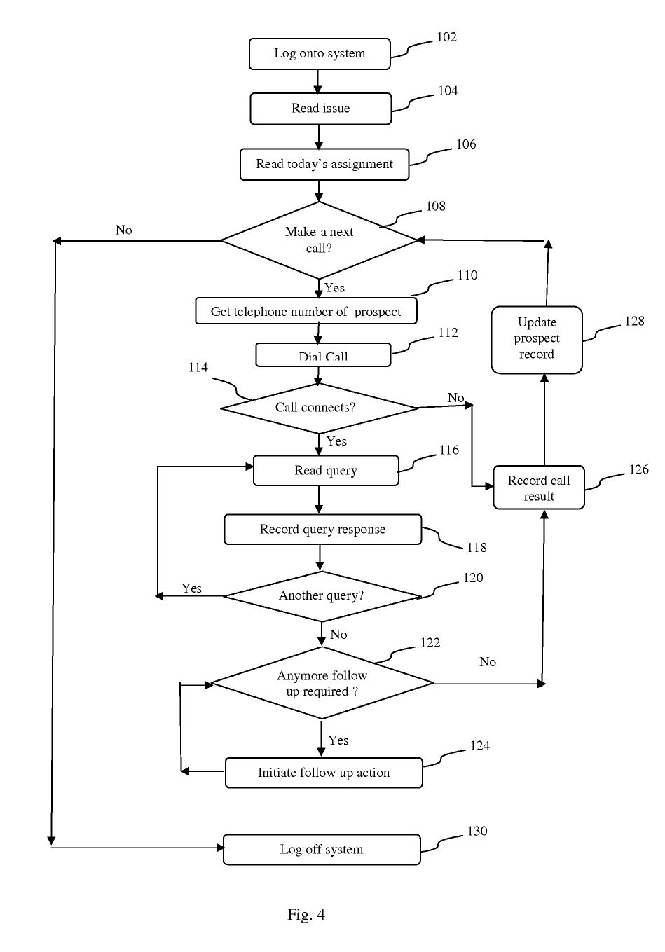

FIG. 4 shows a schematic flow diagram of a volunteer's interaction with the distributed, web-based call system of this invention. In step 102, the volunteer logs on to the system. In the preferred embodiment this may include identity authentication by a user name and password or a suitable biometric system such as, but not limited to, an iris scanner or fingerprint reader. Once logged onto the system, in step 104 the volunteer reads an HTML page served to their browser containing information about the issue that is the subject of the current telephone calling campaign that the volunteer may select to be a part of. In step 106 the volunteer goes on to read about the details of the task assigned to them today. In step 108, the volunteer then elects whether or not they are ready to participate in the assignment and begin making calls to prospects. If the volunteer is ready to begin calling they go to step 110 and access the prospect call page of the first prospect on their call list. In step 112 the volunteer dials the prospects telephone call. If the call connects in step 114, the prospect moves to step 116 and begins a telephone conversation with the prospect by reading the first query or text presented to them on the prospect call page. In step 118, the volunteer records the prospects response to the query. In the preferred embodiment, this recording is facilitated by appropriate HTML features embedded in the prospect call web page such as, but not limited to, check boxes, buttons and pull down menus. The prospect responses may be relayed back to the call center managing system's managing server in real time and used to guide the volunteer/prospect conversation by serving up appropriate text or queries for the volunteer to read. Alternatively the prospect responses may be stored locally on the volunteer's station and sent back as a batch either at the end of a particular volunteer/prospect conversation or at the end of a volunteer session. Having recorded the query response, volunteer goes to step 120 and determines if there is another query or script text element to be conveyed to the prospect. If there is another query, volunteer loops back to step 116 of reading the query. If there is no further query to be read, the volunteer then goes to step 122 of determining if there is any follow up action to be taken. If there is follow up action, the volunteer then goes to step 124 of initiating the follow up action which may for example be, but is not limited to, e-mailing the prospect a package of actionable materials or notifying the call center managing system of a need to send a package of actionable materials by regular mail to the prospect.

Once the volunteer determines that there is no further follow up required, they move on to step 126 of recording the call result. This recording may be simplified by check boxes or buttons corresponding to common results such as, but not limited to the prospect not answering, hanging up, having no interest, being a supporter, being an activist or the call being disconnected. The volunteer then moves onto step 128 of updating a prospects record or causing it to be updated. Having completed dealing with a given prospect, the volunteer loops back to step 108 to find if there is another prospect on their to-call list and to decide whether or not to call the next prospect at this time. If there are no new prospects waiting to be called, the volunteer may, in one embodiment of the invention, be automatically forward to a reserve deck of prospects. This reserve deck may for instance include, but is not limited to, lists of prospects which previous attempts had been either unsuccessful or only partially successful or they may represent lists of prospects that for some historical, demographic, geographic or socio-graphic reason, was not considered to be appropriate to include on the first list of prospects to call. When the volunteer has completed their calls to their allotted prospects for the day, or when they have used up all the time they can allocate to the task for the day, they go to step 130 of logging off the system.

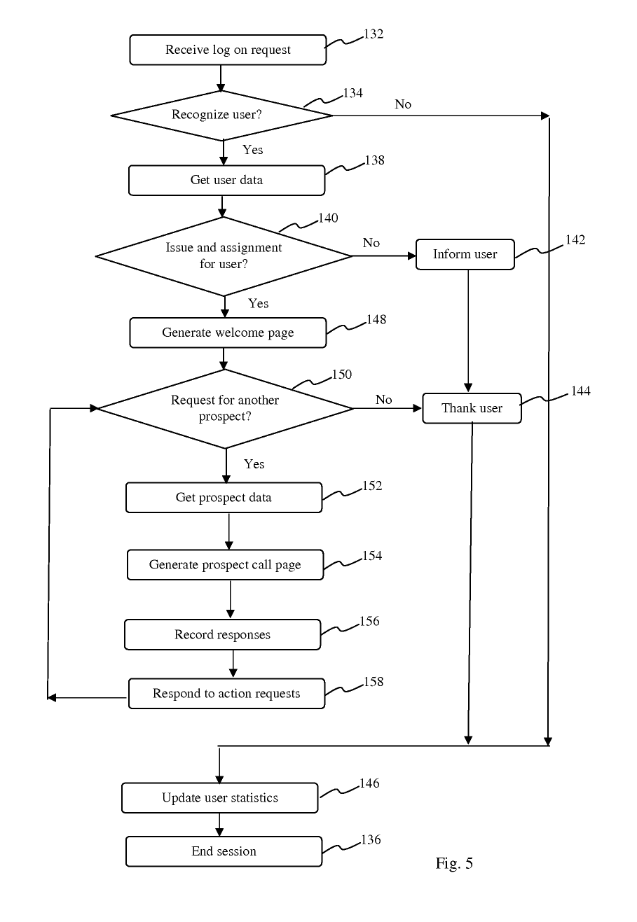

FIG. 5 is a schematic flow chart detailing how the web based distributed call center processes input from and output to a volunteer station. In step 132 the system receives a log on request from a volunteer user. In step 134 the system determines whether it recognizes the user. The recognition step 134 may consist of querying a database to see if the identification presented by the user corresponds to stored data. For instance, the step 134 may consist of checking whether a volunteer is presenting a user name and user password that correspond to a user name and associated password stored in a call center managing system database. The identification presented and stored may include, but is not limited to, other systems such as voice-recognition, iris-pattern matching, finger print matching and other known biometric systems. If the user is not recognized, the system ends the system in step 136. If the user is recognized, the call center managing system retrieves relevant user or volunteer data from its historical databases such as its volunteer database. Having obtained the relevant information about the user or volunteer who has logged onto the system in step 138, the system proceeds to step 140 of ascertaining what, if any, task to assign the volunteer. If their are no tasks currently suitable for the volunteer, the system takes step 142 of informing the user, then proceeding to step 144 of thanking the user for volunteering. The system then takes step 146 of updating the user or volunteer statistics. This may include recording that the user volunteered but there was no suitable task and altering selection criteria to improve the chances of the user being given an assignment the next time the user volunteers. If the system in step 140 has an assignment for the user, it proceeds to step 148 of issuing the user a welcome page that sets out the assignment, including the issues and links to background material to help orient and motive the volunteer. The welcome page also includes, or includes links to, lists of prospects. In the preferred embodiment, these prospect lists have been pre-qualified by automate call systems. The system then waits for a request for a prospect to call. When the system is asked for a prospect to call in step 150, the system proceeds to step 152 of getting the prospect data. This typically consists of accessing a prospects database. Once the system has the prospect data, it generates a prospect call page in step 154. This call page has details about the prospect, including a telephone number, as well as a personalized calling script to guide the volunteer in talking to the prospect. The next step the system takes is step 156 of recording the prospects responses as interpreted by the volunteer. In step 158 the system responds to any action requests such as, but not limited to, sending the prospect an e-mail package or a package by regular mail. Having responding to any action requests, the system loops back to step 150 of checking to see if there is a request for another prospect. When there are no further requests for prospects, the system then issues an appropriate thank you message in step 144 before updating the user statistics in step 146 and then ending the session in step 136.

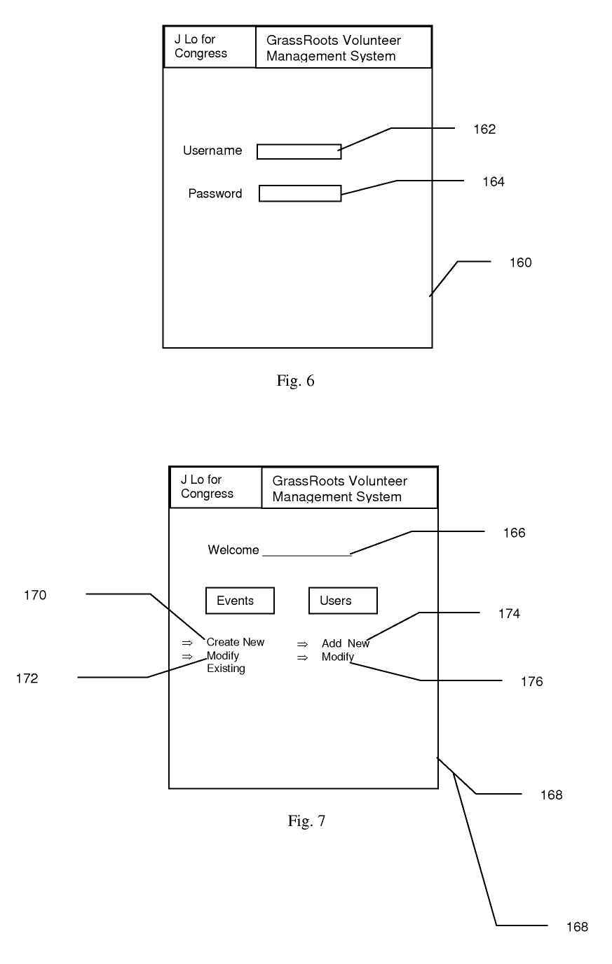

FIG. 6 is an exemplary log on page 160. Both administrators and volunteers may see a similar log on page each time they use the system. The administrator may be an internal administrator (also known as a web army mobilizer (WAM) administrator) responsible for administering a system which is capable of hosting a plurality of clients. Each client typically has at least one client administrator to administer their own lists and databases. A WAM administrator may, for instance, set up the system by providing access codes and security settings to allow a portion of the system to be administered by a client administrator. The log on page 160 typically comprises a field for entering a user name 162 and a field for entering a password 164.

FIG. 7 is an exemplary administrator's welcome page 168, which may be a client administrator's welcome page. The client administrator typically has system privileges that allow them to manage campaign lists. In addition to a personalized welcome message 166, the client administrator's welcome page 168 typically comprises links that allow the client administrator to create new events 170 or to modify existing events 172, or to add new users 174 or to modify data related to existing users 176. The client administrator may also import data into the system by, for instance, upload data into the prospect database 20 or the volunteer database 22.

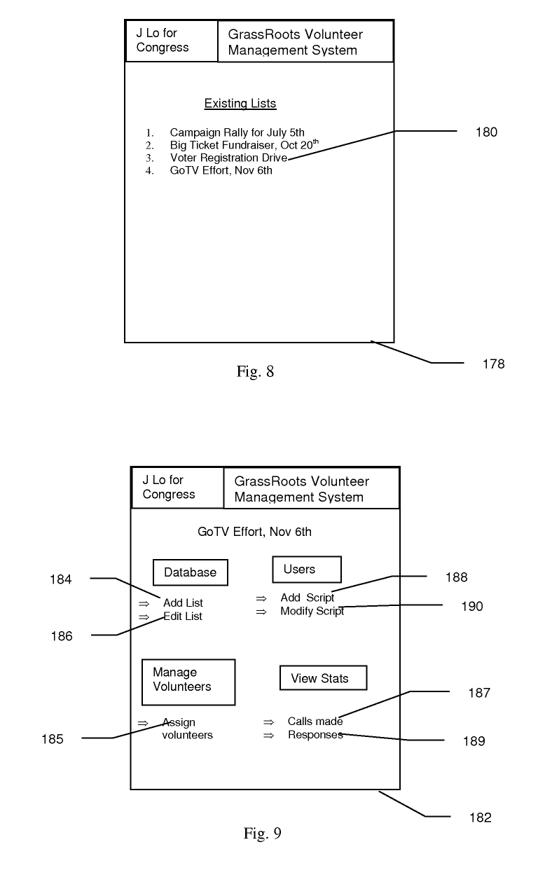

FIG. 8 is an exemplary administrator's list overview page 178, which typically comprises links to existing lists 180.

FIG. 9 is an exemplary administrator's list management page 182, which typically contains links which allow the administrator to manage a particular event or campaign. The elements needed to manage a campaign typically comprise a link to add lists 184 to the database, either of prospects to be contacted or volunteers to contact them, a link to edit existing lists 186, either of prospects or volunteers, a link to add a script 188, a link to modify an existing script 190, a link to manage volunteers by assigning the volunteers to a particular event or campaign 185, a link to view statistics related to the calls that have been made 187 and a link to view statistics related to the response obtained 189.

FIG. 10 is an exemplary administrator's script management page, 190, that typically comprises a text box that allows entry of information describing the issue or event 192, a text box for entry of information that describes the goal of the event 194, a text box for entry of a script to be used by the volunteer in discussing the issue with the prospect 196 and a text box for entry of a question that the volunteer should ask the prospect 198. The administrator's script management page typically has a response area that allows the administrator to, for instance, place and name check boxes such as, but not limited to, a “Yes” check box 193, a “No” checkbox 195 and a “Maybe” check box 197. These checkboxes allow the volunteer to efficiently record a prospect's response.

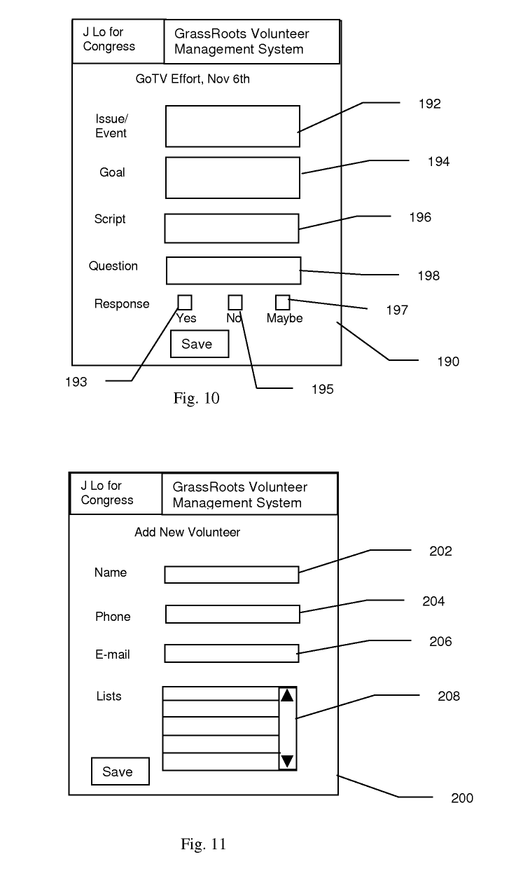

FIG. 11 is an exemplary administrator's volunteer enrollment and assignment page 200 that typically comprises a field for entering a new volunteer's name 202, a field for entering a new volunteer's phone number 204, a field for entering a new volunteer's e-mail address 206 and a scrollable text area 208 that allows the administrator to assign the new volunteer to particular events or lists.

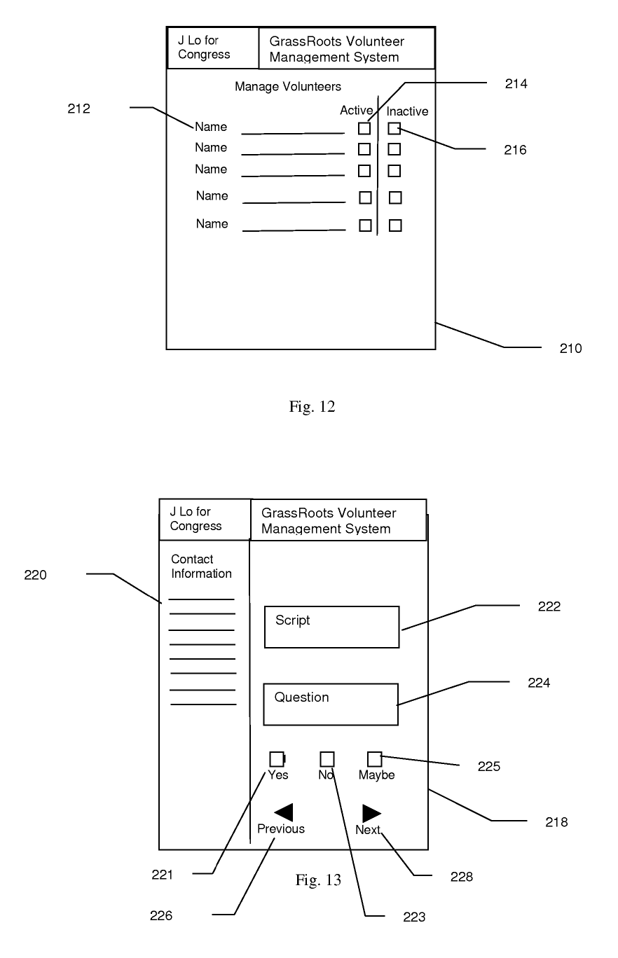

FIG. 12 is an exemplary administrator's volunteer management page 210 that allows the administrator to oversee the status of volunteers. The administrator's volunteer management page 210 typically comprises identification information for the volunteer 212, such as their name, a check box indicating if the named volunteer is currently active 214, and a check box indicting if the named volunteer is inactive 216.

FIG. 13 is an exemplary volunteer's action page 218 that typically comprises an area containing contact information related to the prospect to be called 220, a message template, which may be a script or a customized message to be read to the prospect 222, and a question to be asked of the prospect 224. The volunteer's action page 218 typically also comprises arrow buttons to display the next contact 228 or the previous contact 226, and response check buttons such as but not limited to “Yes” button 221, “No” button 223 and “Maybe” button 225, for rapid recording of a prospects reaction to the question.

As detailed above, in a preferred embodiment of the invention, the call center management system provides web pages containing prospect contact information, conversation scripts personalized to reflect known information about both the volunteer and the prospect, and selectable buttons for recording prospect responses and conversation outcomes. In a preferred embodiment, the volunteer uses a conventional phone to contact the prospect and to conduct a scripted conversation, based on the material supplied in the web page.

The call center management system facilitates follow up actions including e-mailings and regular mailings. These follow up actions may be customized to the prospect based on their recorded responses to the scripts

In a further embodiment of the invention, the management system may alter the scripts in real time in response to the prospect responses, providing a computer guided conversation

In a further embodiment of the invention, the management system may monitor the volunteers performance and efficiency

In a further embodiment the volunteer monitoring may be done in real time and automated motivational actions may be taken, including automatically sending humorous and/or motivational materials, including graphics and audio.

In a further embodiment of the invention, the volunteer monitoring may be used to provide automated reward generation for volunteers

In a further embodiment of the invention, the volunteer monitoring may result in scoring of the volunteers. This scoring may be kept private, or it may be shared, in whole or in part, with other volunteers to provide a competitive atmosphere.

In a further embodiment of the invention, the type and scale of assignment may be customized in real time at the time the volunteer logs onto the system to reflect the historical assessment of that particular volunteer. For instance, a volunteer with a superior record of getting positive responses from a prospect may preferentially be referred prospects considered important to a particular task. Similarly, a volunteer with a superior record of efficiency may be assigned a commensurately larger number of prospects. The managing server may, for instance, run software that ranks both volunteers and prospects, and then use those ranked lists to determine how the prospect lists are distributed. For instance, volunteers may be ranked based on the recorded responses, with higher ranked volunteers being the ones who, on average, obtain successful responses, either in the form of more donations, larger average donations, or more positive commitments to action. The rankings may also be time weighted, with more recent responses counting more than older ones. The prospects may also be ranked by, for instance, their past history of donations or commitments or by their demographics and how those demographics, such as age, gender, income, location and education, relate to a particular issue. Higher ranked prospects reflect prospects that are more likely to influence the outcome of an issue. The managing server software may then preferentially assign higher ranked prospects to higher ranked volunteers.

In a further embodiment of the invention, the system is proactive, sending volunteers e-mail or instant messages to encourage them to log on and volunteer for a particular campaign.

In a further embodiment of the invention, the system serves up pages containing background or training type material to assist the volunteers. The type and scope of material may be customized by the system to reflect the volunteer's historical experience or assessment. The material may include audio-visual components, including video and audio. So in addition to managing the calling, the system may in real time manage the training of the volunteers.

In the field of campaign management, there is significant interest in systems and methods of communications management for a distributed call center. Such distributed call center systems and method for volunteer mobilization would be of considerable utility as, for instance, in promoting a candidate during a political election. Such systems and methods would also be useful in the general fields of marketing and advertising.

The present invention improves on previously described call centers in the at least the following ways.

The improved call center system of a preferred embodiment of this invention is a method and GUI configured to allow the Client Administrator to enter any number of possible follow-up texts into the system, each linked directly to an Answer Option. For instance, if a Call Script asks the Question, “Do you plan to vote for Congressman Smith?” and offers two Answer Options—“Yes” and “No”—a follow-up text can be linked to the “Yes” Answer Option that begins “I'm glad you support Congressman Smith,” and a different follow-up text can be linked to the “No” Answer Option that begins, “Let me explain why I believe Congressman Smith merits support.”

Further, in accordance with the present invention, a call center is configured to allow as many emails, or other follow up messages (e.g., voice mail, emails, letters or combinations thereof), as there are questions. The e-mails could be composite emails with elements, including graphic or voice elements, responsive to each of the response options.

The call center of the present invention allows a Client Administrator not only to enter different Follow-up Communication texts into the system relating to a single question, but also different texts into the system relating to multiple questions. Thus, at the conclusion of a call, a callee may receive several emails from a campaign, each tailored to the specific way a callee answered a specific question.

This contrasts with previously implemented distributed call center systems, where follow-up Emails are typically only sent out when a volunteer clicks on a “Send E-Mail” button on the Call Page. The improved call center system of preferred embodiment of this invention sends out the appropriate Follow-up Email automatically whenever the volunteer clicks on an Answer Option with which that Follow-up Email has been linked. In other words, the volunteer does not have to click on an Answer Option to record a callee's response to a question, and then also click on a Send E-Mail button to send that callee a Follow-up Email. All the volunteer has to do is click on the Answer Option, and the system will both record the callee's response to a Question, and send out the linked Follow-up Email.

Further, in previously implemented distributed call center systems, the system typically only allows Follow-up Communications to be emailed. The improved call center system of preferred embodiment of this invention allows Follow-up Communications to be delivered via Email, Fax, Letter or Telephone Call. The System Administrator may first input a script Question, and next a set of Answer Options. The Client Administrator may then choose to link an Answer Option to a Follow-up Communication, and input the Follow-up Communication Text in any of several Follow-up Communication Text Boxes—i.e. the Follow-up Communication Text Box for Emailing, Faxing, Sending a Letter or Calling. The Client Administrator may then instruct the system as to the Prioritization of Follow-up Communication Means—e.g. the Client Administrator could instruct the system to Email a Follow-up Communication if the system has an email address for the callee, or if it does not, to Fax a Follow-up Communication if the system has a fax number for the callee, or if it does not again, to Mail a Follow-Communication if the system has a mailing address for the callee, or if it does not again, to prepare a Telephone Follow-up Communication to the callee. The Client Administrator chooses what the Prioritization of Follow-up Communication Means will be, and the system responds by checking if the necessary data for a prioritized Means is available, and if not, looking to the next Means prioritized, until it finds a Means for which the necessary data is available.

Previously implemented distributed call center systems typically had limited communication customization. The improved call center system of a preferred embodiment of the present invention allows improved customization of communications including, but not limited to, customization that is based not only on the basis of a callee's responses, but also on the basis of information that may have been in the callee databank even before the call was made.

The information may include, but is not limited to, nicknames, previously recorded responses, previous actions such as donations, attendance at events, or causes or campaigns donated to.

Previously implemented distributed call center systems typically only allowed the Client Administrator to code a volunteer in one of two ways. In the improved call center system of a preferred embodiment of the present invention, the Client Administrator may code volunteers in an unlimited number of ways.

Further, with previously-implemented distributed call center systems, Client Administrators do not generally assign the new volunteer to particular events or lists. Instead, they typically give volunteers a “Volunteer-Type” code—e.g. General Volunteer; Fundraising Volunteer, Get-Out-The-Vote Volunteer. Then, when entering an assignment into the new system via its Assignment Set-Up option, the Client Administrator may delegate the assignment to a particular Volunteer-Type. In the improved call center system of a preferred embodiment of the present invention, the system then queries the Administrator as to where in that Volunteer-Type's “Assignment Queue” the new assignment should be placed.

In an improved call center system of a further preferred embodiment of the present invention a Client Administrator may give a single individual more than one Volunteer-Type code, and then prioritize which code has priority for that volunteer. In such a system, when a volunteer logs in, the system may first look at all of the Volunteer-Type codes pertaining to that individual volunteer, it may then check and see which Volunteer-Types currently have an active assignment delegated to them. It may then look at the Volunteer-Type prioritization for that individual volunteer. Finally, it may look at the Assignment Queue for that prioritized Volunteer-Type, and take that individual volunteer directly to the Volunteer Welcome Page for that Assignment.

In previously implemented distributed call center systems, when the user is recognized, the call center managing system typically retrieves relevant user or volunteer data from its historical databases such as its volunteer database. Having obtained the relevant information about the user or volunteer who has logged onto the system proceeds to ascertain what, if any, task to assign the volunteer.

In an improved call center system of a preferred embodiment of the present invention a single Login Page may be used by all volunteers for all campaigns. In such a system, when a volunteer logs in, the volunteer may be taken to a Volunteer Welcome Page where the volunteer may whose which Client he or she wants to volunteer for (given that the volunteer may have been registered as a volunteer for more than one of the operating system's client). Next, the volunteer may chose which assignment he or she wants to work on (given that more than one assignment may have been entered into the system for a given group of volunteers of a client). Only then does text fill in under the “Background Information” and “Today's Assignment” headings.

In an improved call center system of a preferred embodiment of the present invention volunteers may Login at a client-specific Login Page. Once they have logged in, they are brought to a Volunteer Welcome Page where there are no “Client” or “Assignment” drop-down boxes from which to choose, and where text is already filled in below the Background Information and Today's Assignment headings. This keeps the Client Administrator in control of which volunteers are working on which assignments, and makes it easier for a volunteer to just begin working without having to first make a lot of decisions. The Today's Assignment headings may be selected automatically by the system based on, for instance, the volunteer's type code and the current assignment queue for that type code.

In previously implemented distributed call center systems, the web site or the computer hosting the site may further monitor volunteer productivity and effectiveness in order to facilitate the most effective or productive list distribution. The previously implemented systems, however, typically allowed the Client Administrator to search for individual volunteers, but not to sort volunteer records. The improved call center system of a preferred embodiment of the present invention enables the Client Administrator not only to search for individual records, but also to sort the volunteer record list by Name, Volunteer-Type, Number of Calls Made, State, County, City, and Zip, or any combination of the above.

In previously implemented distributed call center systems, a Daily Volunteers and Volunteer History report typically simply allows the Client Administrator to see which volunteers were logged into the system on a given day or set of days, exactly when they were logged on, how many calls they made on that day or set of days, and the disposition of each call. In the improved call center system of a preferred embodiment of the present invention, the Volunteer History report allows the Client Administrator to select the time frame the Administrator wants to look at (a day or set of days), select either a particular assignment to look at or all assignments, and then see the total number of calls made connected with each selected assignment, exactly when each such call was made, how long each such call lasted, the name and email address of the volunteer making each such call, and each volunteer's Volunteer-Type.

Additionally, the improved call center system of a preferred embodiment of the present invention has an Individual Performance report that allows the Client Administrator to select a volunteer, select the dates during which the Administrator wants to review that volunteer's activity, select an assignment (or all assignments) with which the Administrator wants to review that volunteer's activity, and then see exactly how many calls that volunteer made in connection with the selected assignment, the average duration of such calls, and in connection with each question for which an answer was received by the volunteer, to see the number of times (and percentage of times) a given answer was received by the volunteer versus each other Answer Option for that particular question. If interested, the Client Administrator can also get more detailed information relating to the calls a volunteer made, such as the exact date and time each call was made by the volunteer, the duration of each specific call, and the disposition of each specific call.

Additionally, the improved call center system of a preferred embodiment of the present invention has an Individual Performance Ranked report that allows the Client Administrator to select the Volunteer-Types that the Administrator wants to review, the dates that the Administrator wants to review, and the assignments (or all assignments) that the Administrator wants to review, and then to choose one of several criterion by which the Administrator wants individual volunteers to be ranked, such as the number of calls made in connection with an assignment or all assignments, the average duration of calls made in connection with each assignment worked on, the completion percentage of calls made in connection with each assignment worked on (i.e. calls where a live callee stayed on the phone throughout all of the questions), and the key answer percentage of calls made in connection with each assignment worked on (i.e. the percentage of times a given volunteer received a particular response from callees in response to a question chosen by the Administrator to be reviewed).

Additionally, the improved call center system of a preferred embodiment of the present invention has a Type Performance report that allows the Client Administrator to select the Volunteer-Type the Administrator wants to be reviewed, the dates to be reviewed, the assignment (or all assignments) to be reviewed, the total number of calls made relative to each selected assignment by the Volunteer-Type group, the average duration of calls made by the group in connection with the selected assignment, and the number of times (and percentage of times) a given answer was received by a group in response to an assignment's questions.

These reports give a Client Administrator the ability to monitor volunteer performance carefully so that effective volunteers can be recognized, and volunteers mis-using the system can be detected. To provide an example of how these reports could help detect system mis-use, a Client Administrator could look at the Individual Performance Ranked report and note that at one end of the ranking a particular volunteer was taking just 5 seconds to complete calls, while the Volunteer-Type report revealed that on average group members were taking 3 minutes to complete the same call. This would suggest that the volunteer was not actually making any calls, and was instead just falsifying data. The Administrator could then look at the Individual Performance report, see exactly when some of the quick calls were supposedly made, track down through the system whom those calls were supposed made to, and phone the callee to see if the callee ever received the supposed call.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, or CD ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, FIGS. 1-2 support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

What is claimed:

1. In a communications management method for a distributed call center, comprising providing a managing server; providing a display device located geographically distant from said managing server; providing a communications device, located in proximity to said display device; providing an operator capable of operating said communications device; sending a message template and prospect identification information related to a prospect from said managing server to said display device; displaying, on said display device, said message template and said identification information; initiating communication with said prospect, by said operator, using said identification information and said communications device; creating a customized message using said message template and said prospect identification information; conveying, by said operator, said customized message to said named prospect; and recording a response of said prospect by said operator, and sending said recorded response to said managing server, an improvement comprising:
automatically preparing and sending a follow-up communication to said named prospect when said operator records the response of said named prospect.

2. The method of claim 1, wherein said customized message comprises multiple questions deliverable to said named prospect, and wherein a follow-up communication to said named prospect is automatically generated for each question answered by said named prospect.

3. The method of claim 1, wherein multiple operators are provided each capable of operating a separate communications device, wherein each operator is a volunteer, further comprising:
assigning at least one volunteer-type code to each volunteer based on a type of volunteer assignment to be performed by each volunteer;
identifying a volunteer assignment type associated with each type of volunteer assignment; and
establishing an assignment queue which automatically assigns assignments to by based on the volunteer assignment type.

4. In a distributed call center system, comprising a managing server; a display device located geographically distant from said managing server; a communications device, located in proximity to said display device, capable of being operated by an operator; a first communications module capable of sending a message template and prospect identification information related to a prospect from said managing server to said display device; a display module capable of displaying, on said display device, said message template and said identification information; a customized message comprising said message template and said prospect identification information; and a communication link between said operator and said prospect, capable of being initiated by said operator using said identification information and said communications device, whereby said customized message is conveyed to said named prospect by said operator, an improvement comprising:
means within said distributed call center system for automatically preparing and sending a follow-up communication to said named prospect when said operator records the response of said named prospect.

5. The system of claim 4, wherein said customized message comprises multiple questions deliverable to said named prospect, and further comprising means for automatically generating a follow-up communication to said named prospect for each question answered by said named prospect.

6. The system of claim 5, wherein multiple communications devices are provided, one for each of a plurality of operators, wherein each operator is a volunteer, further comprising:
means for assigning at least one volunteer-type code to each volunteer based on a type of volunteer assignment to be performed by each volunteer;
means for identifying a volunteer assignment type associated with each type of volunteer assignment; and
means for establishing an assignment queue which automatically assigns assignments to by based on the volunteer assignment type.

7. In a distributed call center apparatus, comprising a managing server; a data-receiving device located geographically distant from said managing server; first communications means for sending a message template and prospect identification information related to a prospect from said managing server to said data receiving device; a display means, located in proximity to said data-receiving device, for displaying said message template and said identification information; a communications means, located in proximity to said display device, capable of being operated by an operator; a customized message comprising said message template and said prospect identification information; and a communication means, capable of being initiated by said operator using said identification information and said communications device, for conveying, by said operator, said customized message to said named prospect, an improvement comprising:
means for automatically preparing and sending a follow-up communication to said named prospect when said operator records the response of said named prospect.

8. The apparatus of claim 7, wherein said customized message comprises multiple questions deliverable to said named prospect, and further comprising:
means for automatically generating a follow-up communication to said named prospect for each question answered by said named prospect.

9. The apparatus of claim 8, wherein multiple operators are provided each capable of operating a separate communications device, wherein each operator is a volunteer, further comprising:
means for assigning at least one volunteer-type code to each volunteer based on a type of volunteer assignment to be performed by each volunteer;
means for identifying a volunteer assignment type associated with each type of volunteer assignment; and
means for establishing an assignment queue which automatically assigns assignments to by based on the volunteer assignment type.
